(19) United States
(12) Patent Application Publication
(10) Pub. No.: US 2006/0274945 A1
(43) Pub. Date: Dec. 7, 2006

(54) System and method for automatically extracting a picture of a person from a government issued identification piece for use on a badge

(76) Inventors: Soy L. Chu, Reston, VA (US); Edward L. Chu, Ashburn, VA (US)

Correspondence Address: WENDEROTH, LIND & PONACK, L.L.P., 2033 K STREET N. W., SUITE 800, WASHINGTON, DC, 20006-1021, US

(21) Appl. No.: 11/143,633

(22) Filed: Jun. 3, 2005

(51) Int. Cl. G06K 9/46; G06K 9/66

(52) U.S. Cl. 382/190

(57) ABSTRACT

A photo ID badge issuing system includes a scanning unit operable to capture an electronic copy of a government issued picture ID or passport of a person. The photo ID badge issuing system then extracts an electronic image of the person from the electronic copy of the government issued picture ID or passport and generates a photo ID badge using the extracted electronic image. By using the electronic image from the government issued picture ID or passport, the photo ID badge issuing system eliminates the need to interface with a digital camera or similar device, and also eliminates the extra time spent capturing a new digital image of the person with the digital camera.

### BACKGROUND OF THE INVENTION

1. Field of the Invention

The present invention relates to a system and method for generating photo ID badges using pictures previously included in government issued picture IDs or passports.

2. Description of the Related Art

Existing badge generating systems utilize an external digital camera or similar device 701 to capture a person's picture for inclusion in a badge as illustrated in FIG. 7. The general process employed by these systems includes: (1) having the person pose for image capture using the external digital camera or similar device (e.g., web cam) 701; (2) transferring the captured image to a CPU or computer system 702; and (3) using the captured image to create a badge with a printer 703. However, none of these badge generating systems is capable of creating a badge by capturing a person's image without the use of an external camera or similar device.

### SUMMARY OF THE INVENTION

An object of the present invention is to provide a simple, automated system and method for generating a photo ID badge utilizing an existing identification piece such as a government issued picture ID or passport.

To achieve the above-described object, a photo ID badge issuing system is provided that comprises a scanning unit operable to capture an electronic copy of the government issued picture ID or passport, a computer or customized processor (CPU) operable to extract a picture from the electronic copy of the government issued picture ID or passport, and a printing unit operable to generate a photo ID badge using the extracted picture.

When a photo ID badge is to be generated for a person, the scanning unit is used to scan the person's government issued picture ID or passport and generate an electronic copy thereof. The electronic copy is then processed by the CPU to extract an electronic image of the person's picture. The extracted image is then processed by the CPU for output to the printing unit, and the printing unit generates the photo ID badge using the extracted image without using a digital camera or similar device.

One of the advantages of the present invention is that it streamlines the standard process for generating a photo ID badge. Specifically, the present invention eliminates the need to interface with a digital camera or similar device, and also eliminates the extra time spent capturing a new digital image of the person with the digital camera or similar device. Further, by extracting the person's picture from a government issued picture ID or passport, security is enhanced because the picture has already met certain requirements regarding its format.

### BRIEF DESCRIPTION OF THE DRAWINGS

FIG. 1 illustrates a photo ID badge issuing system of the present invention;

FIG. 2 illustrates the operation of the photo ID badge issuing system of the present invention;

FIG. 3 illustrates a template displayed on a display device of the present invention;

FIG. 4 illustrates a photo ID badge of the present invention;

FIG. 5 illustrates a verification operation of the present invention;

FIG. 6 illustrates another verification operation of the present invention; and

FIG. 7 illustrates a conventional system for generating a photo ID badge.

### DETAILED DESCRIPTION OF THE INVENTION

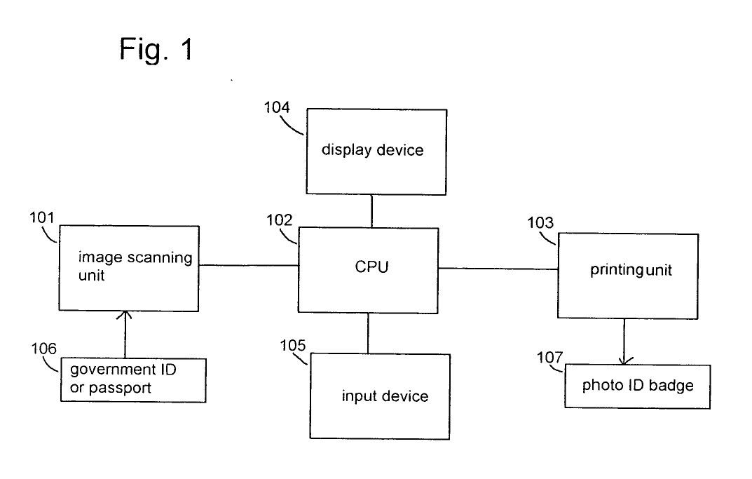

The photo ID badge issuing system of the present invention generates a photo ID badge 107 without the use of a camera device. The photo ID badge issuing system, as illustrated in FIG. 1, includes three main components. These components are: (1) an image scanning unit 101; (2) a CPU 102; and (3) a printing unit 103. Further, the CPU 102 has a display device 104 and an input device 105 associated therewith.

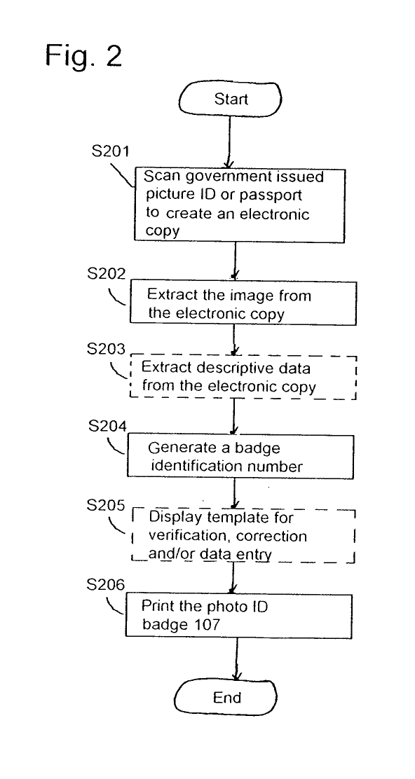

The operation of the photo ID badge issuing system of the present invention discussed below is illustrated in FIG. 2. It is noted that the optional operations of the photo ID badge issuing system are illustrated in FIG. 2 with dashed lines.

The image scanning unit 101 is capable of capturing an electronic copy of an identification piece which includes a picture of a person, such as a government issued picture ID or passport 106 (S201), and sending the electronic copy to the CPU 102. For example, the electronic copy can be sent from the image scanning unit 101 through a cable, a network, the Internet, wirelessly, or by any combination of these transmission methods to the CPU 102.

The CPU 102 is configured to accept the electronic copy of the government issued picture ID or passport 106. Once the CPU 102 receives the electronic copy of the government issued picture ID or passport 106, the CPU 102 stores the electronic copy and extracts the electronic image of the person's picture from the electronic copy of the government issued picture ID or passport 106 (S202). The CPU 102 is capable of extracting the electronic version of the person's picture by defining a picture zone for each format type of government issued picture ID and passport. The CPU 102 then crops the defined picture zone from the electronic copy of the government issued picture ID or passport 106 using standard software development tools.

Further, the CPU 102 can extract descriptive data from the electronic copy of the government issued picture ID or passport 106, such as an expiration date of the government issued picture ID or passport 106, the person's name, address, date of birth (DOB), eye color, hair color, height, and/or any other information printed on the government issued picture ID or passport 106 (S203). The CPU 102 is able to extract the descriptive data using optical character recognition (OCR). The CPU 102 also generates a badge identification number to be associated with the photo ID badge 107 (S204). The badge identification number can be a unique number used exclusively for only one photo ID badge. The badge identification number can also be a uniquely assigned number on a day-by-day, month-by-month, or year-by-year basis. For example, the photo ID badges generated on a given day will all have unique badge identification numbers with respect to each other, but photo ID badges generated on different days could have the same badge identification number.

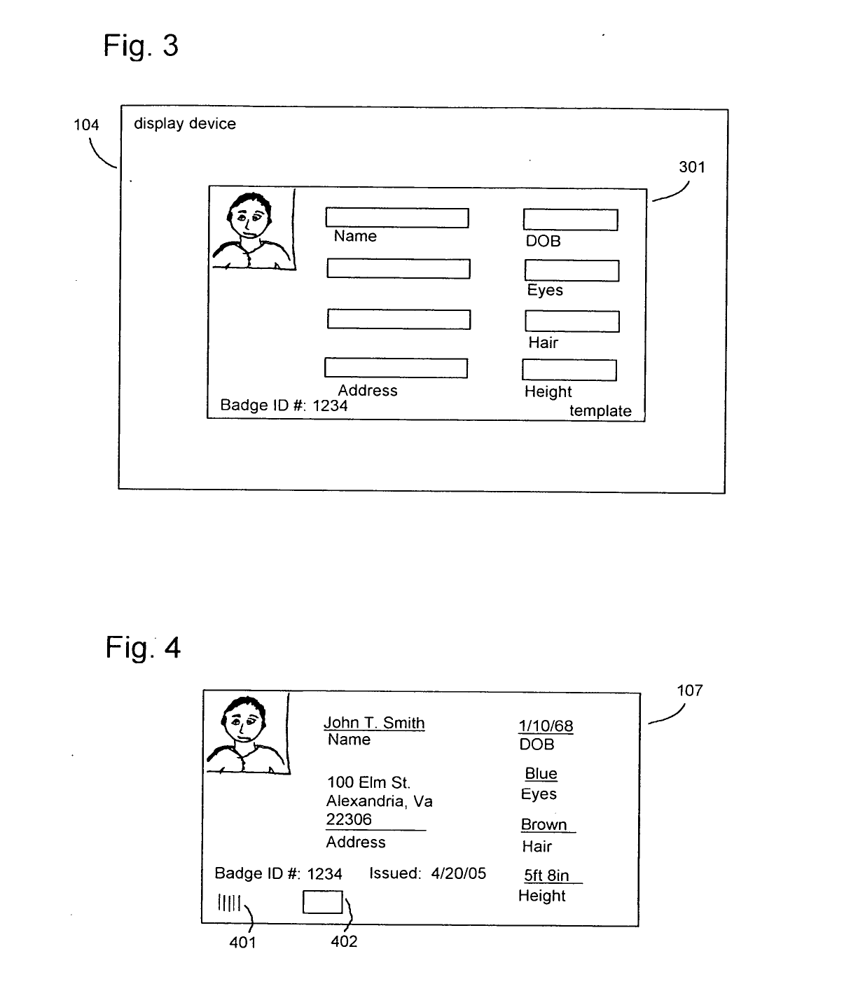

Once the data is extracted, the CPU 102 prepares an electronic version of the photo ID badge 107 as badge generating information including the extracted data and the badge identification number. The badge generating information is initially displayed on the display device 104 to be verified by an operator of the photo ID badge issuing system. The badge generating information can be displayed on the display device 104, for example, in the form of a template 301, as illustrated in FIG. 3, similar to the photo ID badge 107 to be generated (S205). The template 301 will include at least the person's image extracted from the electronic copy of the government issued picture ID or passport 106 and the badge identification number. Once the template 301 is displayed, the CPU 102 provides functions with which the operator can lighten or darken the person's image and perform other operations on the person's image to increase its quality with the input device 105. It is noted that the input device 105 can include one or more of a keyboard, mouse, signature capture unit, light pen or other device.

Further, the template 301 can also include a number of text fields to be filled in with appropriate descriptive data by the operator via the input device 105 or automatically by the CPU 102 with the extracted descriptive data originally printed on the government issued picture ID or passport 106. The CPU 102 also includes functions by which the operator can move, delete, edit or otherwise modify the information in these text fields with the input device 105.

Once the operator instructs the CPU 102 that the template 301 displayed on the display device 104 is acceptable, the CPU 102 updates the badge generating information based on the changes to the template 301 and sends the badge generating information to the printing unit 103 through, for example, a cable, a network, the Internet, wirelessly or by any combination of these transmission methods. Further, the badge generating information and a date/time the photo ID badge was generated can be stored in the CPU 102 either temporarily or permanently.

The printing unit 103 receives the badge generating information from the CPU 102. Once the printing unit 103 receives the badge generating information, the printing unit 103 prints the photo ID badge 107, as illustrated in FIG. 4, including the person's image, the badge identification number, and any extracted or inputted descriptive data as discussed above (S206). Further, the photo ID badge 107 can also include the date it was issued (generated).

In addition to the badge identification number being printed as text on the photo ID badge 107, as discussed above, it is noted that this information can also be printed in the form of a bar code 401. The badge identification number can also be included in a radio frequency ID tag 402 to be incorporated with the photo ID badge 107. The radio frequency ID tag 402 can be read by a radio frequency ID tag reader. When the badge identification number is read a reader or manually entered into a terminal associated with the photo ID badge issuing system, the photo ID badge issuing system can record the badge identification number along with a date/time it was read, as well as retrieve the information associated with the badge identification number that was stored during the process of making the photo ID badge. Further, it is noted that the badge identification number can be included in any combination of the above-discussed formats on the photo ID badge 107.

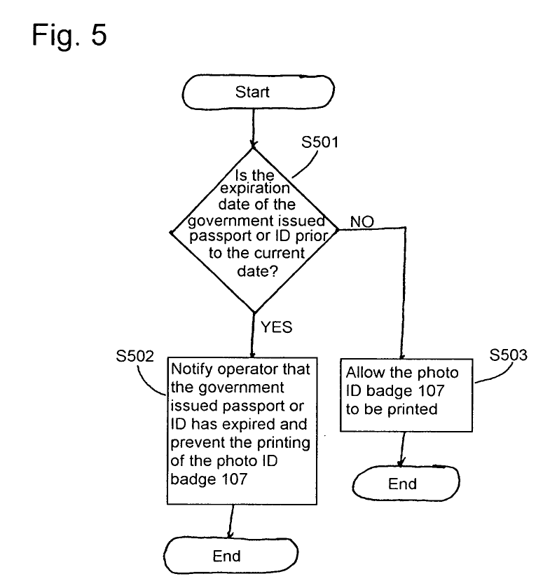

The CPU 102 can also perform one or more verification processes on the descriptive data and the person's image extracted from the electronic copy of the government issued picture ID or passport 106. If the verification process determines that a problem exists, the CPU 102 can provide an indication of the problem (i.e., a message) to the operator via the display device 104 and prevent the photo ID badge 107 from being printed by the printing unit 103. An example of a verification process of the CPU 102, as illustrated in FIG. 5, is that the CPU 102 compares the expiration date of the government issued picture ID or passport 106 to the current date (S501). If the CPU 102 determines that the expiration date is prior to the current date, the CPU 102 will display a message to the operator that the government issued picture ID or passport 106 has expired and prevent the printing unit 103 from printing the photo ID badge 107 (S502). Otherwise, the CPU 102 will allow the printing unit 103 to print the photo ID badge 107 (S503).

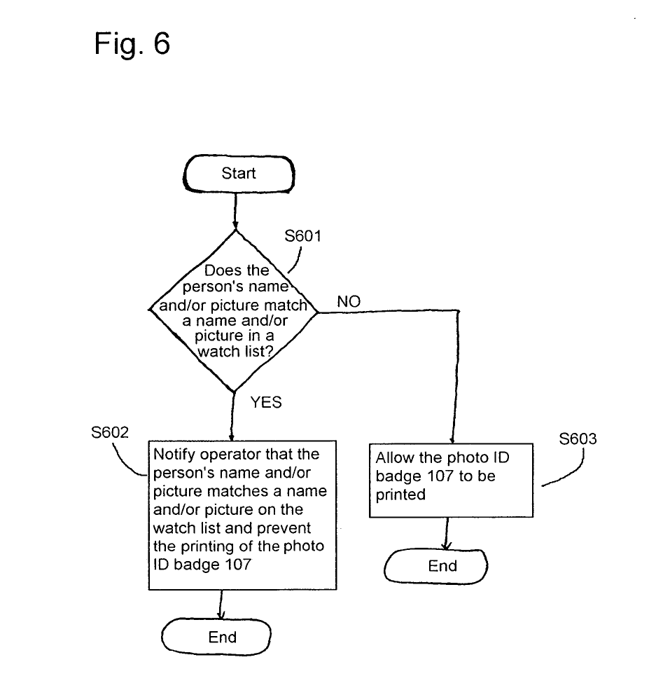

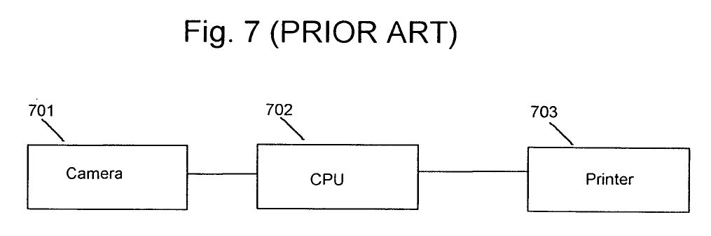

Another example of a verification process of the CPU 102, as illustrated in FIG. 6, is that the CPU 102 compares the person's name and/or the person's image extracted from the government issued picture ID or passport 106 with names and/or pictures on a watch list (e.g., a list of people who have outstanding warrants for their arrest) (S601) stored in a database. This database, for example, can be local or accessed through a network, the Internet, wirelessly or by any combination of these transmission methods. If the CPU 102 determines that the person's name and/or picture matches a name and/or picture in the database associated with the watch list, the CPU 102 will display this information to the operator and prevent the printing unit 103 from printing the photo ID badge 107 (S602). Otherwise, the CPU 102 will allow the printing unit 103 to print the photo ID badge 107 (S603). Further, the CPU 102 may include a function to allow the operator to override the verification processes and control the CPU 102 to allow the printing unit 103 to generate the photo ID badge 107.

An example of the operation of the present invention as described above is now provided.

Initially, a visitor of a site arrives at a checkpoint, such as a front desk or security desk, where the photo ID badge issuing system is located. The visitor provides the operator with the government issued picture ID or passport 106. The operator then takes the government issued picture ID or passport 106 and scans it using the image scanning unit 101. The photo ID badge issuing system automatically captures the electronically scanned copy of the government issued picture ID or passport 106, and the CPU 102 stores the electronic copy either temporarily or permanently.

Next, the CPU 102 automatically extracts the visitor's electronic image from the electronic copy of the government issued picture ID or passport 106. The CPU 102 also automatically extracts the descriptive data (e.g., the expiration date of the government issued picture ID or passport 106, the visitor's name, address, date of birth, eye color, hair color, and/or height) using OCR and stores the information for use on the photo ID badge 107. The CPU 102 then performs a verification process to determine whether the expiration date of the government issued picture ID or passport 106 has passed. If-the CPU 102 determines that the expiration date is prior to the current date, the CPU 102 -will display a message indicating that the government issued picture ID or passport 106 has expired on the display device 104 for the operator and prevent the printing unit 103 from printing the photo ID badge 107.

If the CPU 102 determines that the expiration date is after the current date, the CPU 102 displays the template 301 including the badge identification number, the visitor's image and the descriptive data extracted from the government issued picture ID or passport 106 on the display device 104 for the operator to perform manual verification and correction. At this point, the operator will correct any errors and ensure that the visitor's image is clear by making any necessary adjustments with the input device 105.

Once the operator verifies that all the information displayed in the template 301 on the display device 104 is acceptable, the operator performs an action (e.g., pushes a button) to instruct the CPU 102 to initiate the printing of the visitor's photo ID badge 107 including the badge identification number, the visitor's picture and the descriptive data via the printing unit 103.

Once the photo ID badge 107 is generated, it is affixed to the visitor as long as he/she is on the site. When the visitor departs, the badge identification number is recorded along with the date/time of departure in the photo ID badge issuing system for record keeping purposes.

As detailed above, the present invention can be used by anyone who has a need or desire to generate photo ID badges using a government issued picture ID or passport without using a digital camera. These photo ID badges can be used for visitors, contractors, permanent employees, patient monitoring, etc.

In addition, it is noted that while the present invention has been described in detail, the foregoing description is in all aspects illustrative and not restrictive. It is understood that numerous modifications and variations can be devised without departing from the scope of the invention.

For example, many of the above-described operations of the present invention were indicated as being performed by a CPU. The CPU can be a specialized unit for implementing the operations. Further, the operations can also be in the form of a computer program stored on a computer readable medium or as a signal that can be executed by a general purpose computer.

What is claimed is:

1. A badge issuing system for generating a badge using an identification piece including a picture of a person, the badge issuing system comprising:
an image scanning unit operable to scan the identification piece and generate an electronic copy of the identification piece including an electronic image of the person;
a printing unit; and
a CPU connected to said printing unit and said image scanning unit, said CPU being operable to extract the electronic image of the person from the electronic copy of the identification piece, generate a badge identification number, generate an electronic version of the badge including the electronic image of the person and the badge identification number, and instruct said printing unit to print the badge, including the badge identification number and a picture of the person based on the electronic image of the person, from the electronic version of the badge.

2. A badge issuing system according to claim 1, wherein said CPU is further operable to extract descriptive data from the electronic copy of the identification piece and instruct said printing unit to print the descriptive data on the badge with the picture of the person and the badge identification number.

3. A badge issuing system according to claim 1, further comprising:
a display device connected to said CPU; and
an input device connected to said CPU,
wherein said CPU is further operable to display the electronic version of the badge as a template including the electronic image of the person and the badge identification number on said display device, modify the template based on instructions received from a user via said input device, and update the electronic version of the badge based on the modifications made to the template.

4. A badge issuing system according to claim 2, further comprising:
a display device connected to said CPU; and
an input device connected to said CPU,
wherein said CPU is operable to display the electronic version of the badge as a template including the electronic image of the person, the badge identification number, and at least one text field containing the descriptive data on said display device, modify the template based on instructions received from a user via said input device, and update the electronic version of the badge based on the modifications made to the template.

5. A badge issuing system according to claim 4,
wherein the descriptive data includes an expiration date of the identification piece, and
wherein said CPU is further operable to
compare the expiration date of the identification piece with a current date,
if the expiration date is prior to the current date, display a message that the identification piece is expired on said display device and prevent said printing unit from printing the badge, and
if the expiration date is after the current date, instruct said printing unit to print the badge.

6. A badge issuing system according to claim 4,
wherein the descriptive data includes a name of the person, and
wherein said CPU is further operable to
compare at least one of the name and the electronic image of the person with at least one of names and images of people in a database,
if the at least one of the name and the electronic image of the person matches any of the at least one of the names and the images of the people in the database, display a message that a match has been found on said display device and prevent said printing unit from printing the badge, and
if the at least one of the name and the electronic image of the person does not match any of the at least one of the names and the images of the people in the database, instruct said printing unit to print the badge.

7. A badge issuing system according to claim 1, wherein said printing unit is operable to print the badge identification number as a barcode on the badge.

8. A badge issuing method for generating a badge using an identification piece including a picture of a person, the badge issuing method comprising:
scanning the identification piece and generating an electronic copy of the identification piece including an electronic image of the person;
extracting the electronic image of the person from the electronic copy of the identification piece;
generating a badge identification number;
generating an electronic version of the badge including the electronic image of the person and the badge identification number; and
printing the badge, including the badge identification number and a picture of the person based on the electronic image of the person, from the electronic version of the badge.

9. A badge issuing method according to claim 8, further comprising extracting descriptive data from the electronic copy of the identification piece,
wherein said printing comprises printing the badge including the descriptive data, the picture of the person and the badge identification number.

10. A badge issuing method according to claim 8, further comprising:
displaying the electronic version of the badge as a template including the electronic image of the person and the badge identification number;
modifying the template based on instructions received from a user; and
updating the electronic version of the badge based on said modifying of the template.

11. A badge issuing method according to claim 9, further comprising:
displaying the electronic version of the badge as a template including the electronic image of the person, the badge identification number, and at least one text field containing the descriptive data;
modifying the template based on instructions received from a user; and
updating the electronic version of the badge based on said modifying of the template.

12. A badge issuing method according to claim 11,
wherein the descriptive data includes an expiration date of the identification piece, and
wherein the badge issuing method further comprises:
comparing the expiration date of the identification piece with a current date;
if the expiration date is prior to the current date, displaying a message that the identification piece is expired and preventing said printing of the badge; and
if the expiration date is after the current date, allowing said printing of the badge.

13. A badge issuing method according to claim 11,
wherein the descriptive data includes a name of the person, and
wherein the badge issuing method further comprises:
comparing at least one of the name and the electronic image of the person with at least one of names and images of people in a database;
if the at least one of the name and the electronic image of the person matches any of the at least one of the names and the images of the people in the database, displaying a message that a match has been found and preventing said printing of the badge, and
if the at least one of the name and the image of the person does not match any of the at least one of the names and the images of the people in the database, allowing said printing of the badge.

14. A badge issuing method according to claim 8, wherein said printing comprises printing the badge identification number as a barcode on the badge.

15. A badge issuing program recorded on a computer readable medium for use with a computer, the badge issuing program for generating a badge using an identification piece including a picture of a person, the badge issuing program comprising:
a scanning operation of instructing a scanning unit to scan the identification piece and generate an electronic copy of the identification piece including an electronic image of the person;
an extracting operation of extracting the electronic image of the person from the electronic copy of the identification piece;
a generating operation of generating a badge identification number;
a generating operation of generating an electronic version of the badge including the electronic image of the person and the badge identification number; and
a printing operation of instructing a printing unit to print the badge, including the badge identification number and a picture of the person based on the electronic image of the person, from the electronic version of the badge.

16. A badge issuing program according to claim 15, further comprising an extracting operation of extracting descriptive data from the electronic copy of the identification piece,
wherein said printing operation comprises instructing the printing unit to print the badge including the descriptive data, the picture of the person and the badge identification number.

17. A badge issuing program according to claim 15, further comprising:
a displaying operation of instructing a display device to display the electronic version of the badge as a template including the electronic image of the person and the badge identification number;
a modifying operation of modifying the template based on instructions received from a user via an input device; and
an updating operation of updating the electronic version of the badge based on the modifications made to the template.

18. A badge issuing program according to claim 16, further comprising:
a displaying operation of instructing a display device to display the electronic version of the badge as a template including the electronic image of the person, the badge identification number, and at least one text field containing the descriptive data;
a modifying operation of modifying the template based on instructions received from a user via an input device; and
an updating operation of updating the electronic version of the badge based on the modifications made to the template.

19. A badge issuing program according to claim 18,
wherein the descriptive data includes an expiration date of the identification piece, and
wherein the badge issuing program further comprises:
a comparing operation of comparing the expiration date of the identification piece with a current date;
a displaying operation of instructing the display device to display a message that the identification piece is expired and preventing execution of said printing operation if the expiration date is prior to the current date; and
an allowing operation of allowing execution of said printing operation if the expiration date is after the current date.

20. A badge issuing program according to claim 18,
wherein the descriptive data includes a name of the person, and
wherein the badge issuing program further comprises:
a comparing operation of comparing at least one of the name and the electronic image of the person with at least one of names and images of people in a database;
a displaying operation of instructing the display device to display a message that a match has been found and preventing execution of said printing operation if the at least one of the name and the electronic image of the person matches any of the at least one of the names and the images of the people in the database, and
an allowing operation of allowing execution of said printing operation if the at least one of the name and the electronic image of the person does not match any of the at least one of the names and the images of the people in the database.

21. A badge issuing program according to claim 15, wherein said printing operation comprises instructing the printing unit to print the badge identification number as a barcode on the badge.
